(19) United States
(12) Patent Application Publication
(10) Pub. No.: US 2016/0335713 A1
(43) Pub. Date: Nov. 17, 2016

(54) METHODS FOR VISUALLY REPRESENTING USER-SELECTED CONTENTS OF A PACKAGE

(71) Applicant: ALYK, Inc., New York, NY (US)

(72) Inventors: Alexandra Friedman, New York, NY (US); Jordana Kier, New York, NY (US)

(21) Appl. No.: 15/140,674

(22) Filed: Apr. 28, 2016

Related U.S. Application Data
(60) Provisional application No. 62/179,671, filed on May 14, 2015.

(51) Int. Cl. G06Q 30/06

(52) U.S. Cl. CPC G06Q 30/0643; G06Q 30/0621

(57) ABSTRACT

Methods for providing a real-time, visual representation of a custom assortment of package units selected by a user.

This application claims the benefit of U.S. Provisional Application No. 62/179,671, filed on May 14, 2015, which is incorporated in its entirety herein by reference.

### FIELD OF THE INVENTION

The present invention relates to methods for providing visual feedback of the composition of user-selected contents of a package in real-time as the user is making selections. The methods of the present invention are suitable for any type of item that can be held in a package, with tampons and menstrual pads being particularly preferred.

### BACKGROUND OF THE INVENTION

It is common to employ an Internet website to allow users to select and purchase products, which are then packaged and shipped to the user. In certain instances, the website will permit the user to build customized assortments of a certain product for purchase. In this regard, generally, the website will present a user with a description and/or image of a product with a corresponding text box or selection dropdown and the user will type into the text box or select from the selection dropdown a desired quantity for each of the assorted products to create a custom assortment.

Often, the multitude of text boxes and selection dropdowns can overwhelm and confuse a user, resulting in the user losing track of the entered quantities and further resulting in undesired customized assortments being packaged and shipped to the user. As a consequence, the website has to expend additional money and effort to process returns as well as contend with unhappy customers.

Accordingly, there is a need in the art for a simpler and more intuitive way for a user to design a customized assortment of products on an Internet web site that resolves the shortcomings of the prior art.

In a somewhat related problem, during menstruation, women experience different levels of bleeding, which require the use of tampons or menstrual pads of differing absorbency. However, under the current state of the art, consumers are only accorded an opportunity to order individual packages of tampons or menstrual pads containing all the same type and size of product or an assortment of types/sizes pre-chosen by the seller. Thus, if a consumer wants to use a variety of different types or sizes of product to meet her special wants, she must purchase multiple boxes or packages of such products containing different types/sizes of product.

Accordingly, there is a need in the art for a simpler and more intuitive way for a consumer to design a customized assortment of tampons or menstrual pads that resolves the shortcomings of the prior art.

### SUMMARY OF THE INVENTION

The present invention is directed generally to a method of dynamically displaying in a graphical user interface a visual representation of a set amount of package content units, whereby each unit may be selected by a user from among two or more discrete types, the method including:

a) displaying to the user an array of indicators, wherein each indicator corresponds to one of the set amount of package content units and is capable of two or more visually-distinguishable states;

b) displaying to the user one or more inputs for selecting two or more numeric quantities, whereby each of the numeric quantities corresponds to a desired quantity of units of one of the discrete types, and whereby the inputs are configured to prevent the sum of the numeric quantities from exceeding the set amount of package content units;

c) monitoring the inputs to detect a selection of at least one of the numeric quantities; and

d) automatically setting the state of one or more indicators, whereby each state corresponds to units of one of the discrete types, and whereby the number of indicators set to each state is the same as the selected numeric quantity for units of the corresponding discrete type.

Another embodiment of the present invention is a method of dynamically displaying in a graphical user interface a visual representation of a set amount of package content units, whereby each unit may be selected by a user from among two or more discrete types of units, the method including:

a) displaying to the user an array of indicators, wherein each indicator corresponds to one of the set amount of package content units and is capable of two or more visually-distinguishable states, and wherein each indicator is initialized to one of the states;

b) displaying to the user one or more inputs for selecting two or more numeric quantities, whereby each of the numeric quantities corresponds to a desired quantity of units of one of the discrete types, and whereby the numeric quantities are each initialized to a value such that the sum of the numeric quantities is equal to the set amount of package content units;

c) monitoring the inputs to detect a change to the value of one of the numeric quantities;

d) automatically changing the value of one or more of the other numeric quantities such that the sum of the numeric quantities is equal to the set amount of package content units; and

e) automatically setting the state of one or more indicators, whereby each state corresponds to units of one of the discrete types, and whereby the number of indicators set to each state is the same as the selected numeric quantity for units of the corresponding discrete type.

Thus, the methods described above provide a user with a visual representation of the identity of package content units in real-time as the user is selecting a desired custom assortment of product. In practice, as the user is making a selection of a quantity of product or changing the quantity of product, the array of indicators will dynamically update to reflect the current composition of the user's custom assortment. The visual representation avoids confusion and simplifies the process for selecting a custom assortment of product by making it faster and simpler for the user to accurately confirm that the custom assortment that was chosen is the custom assortment that was actually desired.

The methods described above may further include the steps of receiving over a computer network a request from the user that includes the numeric quantities for units of each of the discrete types; and packing a package with units of each of the discrete types, wherein the quantity of packed units of each of the discrete types is equal to the numeric quantity for units of the discrete type included in the request. Accordingly, the present invention is also directed to methods for packing a package with a set amount of package content units, whereby the type of each unit may be selected by a user from among two or more discrete types.

### BRIEF DESCRIPTION OF THE DRAWINGS

FIG. 1 shows an embodiment of a graphical user interface employed in the methods of the present invention.

FIG. 2 shows an embodiment of a graphical user interface employed in the methods of the present invention.

FIG. 3 shows an embodiment of a graphical user interface employed in the methods of the present invention.

### DETAILED DESCRIPTION OF THE PREFERRED EMBODIMENTS

The methods of graphical user interface of the present invention include displaying to a user an array of indicators 11 that provide a user with a dynamic, real-time visual representation of the user's selections for a custom assortment. The indicators 11 are preferably presented in a graphical user interface 10, such as on an Internet website, viewed through a computer screen. However, it is also contemplated that the indicators may exist as part of a physical apparatus, such as in the form of an LED. In a preferred embodiment, the indicators 11 are arranged in the array as a representation of how the package content units will be arranged once packed in a package, preferably as a top view. It is also preferred that the shape of the indicator 11 is representative of the shape of the package content unit that it represents as seen arranged in a package, preferably from a top view. Thus, for example, if the package content unit is a tampon that will be packed vertically in a package and arranged in three rows of six, the indicators 11 may be circular, representing the shape of a tampon when viewed from above, and in an array of three rows by six columns. Alternatively, for example, if the package content unit is a menstrual pad that will be packed side-by-side in a single row of 12, the indicators 11 may be rectangular, representing the shape of the menstrual pad when viewed from the side, and in an array of one row by 12 columns.

The methods of the present invention may also be used for selecting a custom assortment of other package content units such as food or beverage items, for example, beer (lagers, ales, pilsners, etc.), wine (merlot, chardonnay, pinot grigio, etc.), or candy (dark chocolate, milk chocolate, caramel, etc.).

The total number of indicators 11 in the array will preferably correspond to the number of a set amount of package content units, which is the amount of units that will be included in a custom-assortment package as predetermined by the entity offering the custom-assortment package, usually the seller. Thus, if a certain product is intended to be offered as a 12-pack, i.e., the set amount of package content units is 12, then there will be 12 indicators 11 in the array. Accordingly, each indicator 11 in the array will correspond to one of the units, and will provide a visual representation of a user's selection for that particular unit. Thus, each of the package content units may be selected by a user from a number of discrete types. A “discrete type” refers to items of different categories or items in the same category with different physical specifications. For example, in a package where the content units are tampons or menstrual pads, the discrete types may be light absorbency, regular absorbency, super absorbency, super plus absorbency, or ultra absorbency, or alternatively, the discrete types may be day and night. The discrete types of units that are available for selection by a user is preset, and therefore, a user may only select among the discrete types that are offered. In a preferred embodiment, the discrete types that are available for selection by a user are presented to the user, preferably as part of the graphical user interface 10.

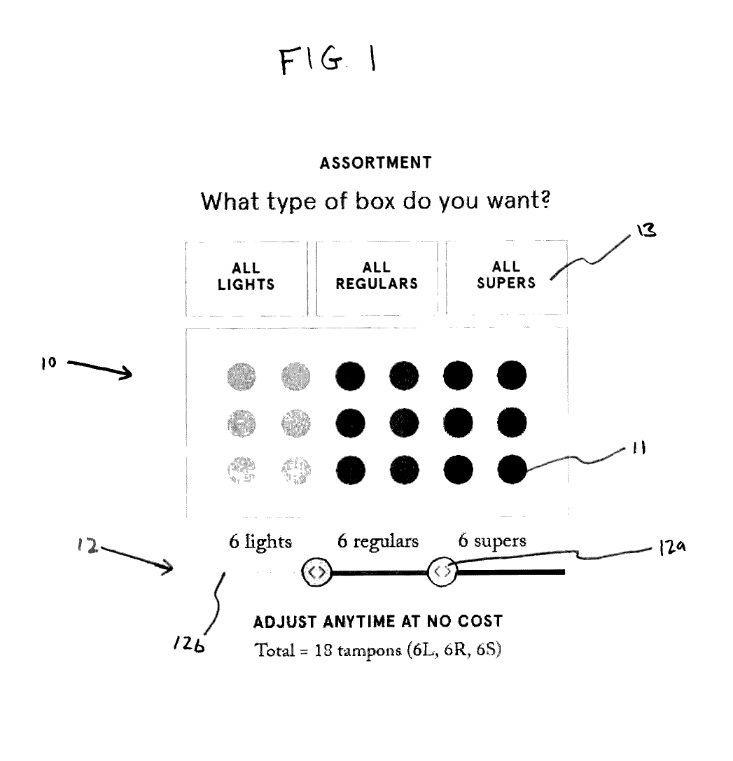

Each of the indicators 11 in the array is capable of two or more visually-distinguishable states, as seen in FIG. 1-3, which show three visually-distinguishable states. A “visually-distinguishable” state refers to a state that is readily perceptible by a human of normal visual acuity as being different from another state. In a preferred embodiment, the visually-distinguishable states may be distinguished by color, shape, pattern, movement, and combinations thereof. Thus, in one embodiment, the visually-distinguishable states may be colors from the set, or any subset, of white, grey, red, orange, yellow, green, blue, purple, brown, and black. In another embodiment, the visually-distinguishable states may be a set of visually-distinguishable shades of any one of the aforementioned colors. In a further embodiment, the visually-distinguishable states may be shapes from the set, or any subset, of rectangle, square, circle, ellipse, crescent, cross, triangle, diamond, pentagon, hexagon, and octagon. Thus, for example, the indicators 11 may have three visually-distinguishable states, such as blue, red, and yellow, or circle, square, and triangle.

In a preferred embodiment, each of the visually-distinguishable states available for a particular indicator 11 will correspond to one of each of the discrete types of units that are available for selection. Thus, for example, if the discrete types of units available for selection are light absorbency, regular absorbency, and super absorbency tampons, then each indicator 11 will have three visually-distinguishable states. Accordingly, if a user were to select four light absorbency tampons, six regular absorbency tampons, and eight super absorbency tampons as a custom assortment, then four indicators 11 would be in a first visually-distinguishable state, six indicators 11 would be in a second visually-distinguishable state, and eight indicators 11 would be in a third visually-distinguishable state.

The methods or graphical user interface of the present invention also include displaying to a user one or more inputs 12 that allow a user to select two or more numeric quantities. The inputs 12 are preferably presented in a graphical user interface 10, such as on an Internet website, viewed through a computer screen. However, it is also contemplated that the inputs may exist as part of a physical apparatus, such as in the form of a button, switch, lever, slider, and/or keypad. As part of a graphical user interface 10, the selection of a numeric quantity can be made through the use of any computer input device known in the art, such as a mouse, keyboard, touchpad, or touchscreen. In a preferred embodiment, each of the numeric quantities selected by the user corresponds to one of each of the discrete types of units that are available and represents the quantity of units of a particular discrete type desired by the user. Thus, for example, if the discrete types of units available for selection are light absorbency, regular absorbency, and super absorbency tampons, the input(s) 12 would allow a user to select three numeric quantities. The numeric quantities may be any number including zero as long as the sum of the numeric quantities equals the set amount of package content units.

The input(s) 12 are preferably any type known in the art suitable for a graphical user interface 10. Preferred inputs 12 are text inputs, radio buttons, check boxes, drop-down lists, or sliders. In a preferred embodiment where each discrete type of unit has a corresponding input, the input may employ a visually-distinguishable accent as part of, or adjacent, the input 12. The visually-distinguishable accent will be the same as the visually-distinguishable state for the indicators 11 of that particular unit type.

In a preferred embodiment, the input is a single slider as shown in FIG. 1-3 having two or more handles 12a that divide the slider bar into a number of portions 12b. In such an embodiment, each of the portions 12b will correspond to one of each of the discrete types of units that are available, the number of handles 12a will be one less than the number of discrete types of units that are available, and the size of each portion 12b in proportion to the overall length of the slider bar represents the numeric quantity for a particular unit type. In a particularly preferred embodiment, each portion 12b includes a visually-distinguishable accent that is the same as the visually-distinguishable state for the indicators 11 of the particular unit type. In the preferred embodiment, the handles 12a may be moved by a user toward either end of the slider but without passing one another, with a rightward or upward movement usually representing a desired increase in quantity, and a leftward or downward movement usually representing a desired decrease in quantity, however the opposite representations are also contemplated.

Because each handle 12a straddles two portions 12b of the slider, when a handle 12a is moved to increase the quantity of one portion 12b, the quantity of the adjacent portion 12b is likewise reduced or vice versa. This is important because the sum of the quantities for each of the portions 12b, i.e., each of the discrete types of units, must equal the set amount of package content units. In embodiments that do not employ the slider input 12 described above, the sum of the numeric quantity values may be computed in the processor of a remote computer, i.e., server side, or computed in the processor of the user's computer, i.e., client side, prior to any further processing and an error shown if the sum of the selected quantities exceeds the set amount of package content units. Alternatively, multiple inputs 12 can be in communication with one another so that when a numeric quantity is selected from an input 12, the numeric quantities that are available for selection from the remaining inputs 12 are automatically adjusted to account for the previous quantity selection(s) so that the user is forced into selecting numeric quantities that sum to the set amount of package content units.

In an embodiment, the methods or graphical user interface of the present invention may also include displaying one or more additional inputs 13 that allow a user to automatically fill the entire set amount of units with only one of the discrete types of units, i.e., one of the numeric quantities is equal to the set amount of units and the remaining numeric quantities are equal to zero. This additional input(s) 13 may be any of the input types discussed above, and is preferably a button.

In an embodiment of the present invention, each indicator 11 is initialized to one of the visually-distinguishable states. In a preferred embodiment, the indicators 11 are divided equally into groups, with the indicators 11 in each group being set to one of the visually-distinguishable states that is a different state from each of the other groups. Initializing the indicators 11 into one of the states provides a starting point for the user to make a custom assortment. In this embodiment, the numeric quantities of the input(s) 12 are also initialized to a value such that the sum of the numeric quantities is equal to the set amount of package content units. In a preferred embodiment, the numeric quantities are initialized to the same value. It should be understood that the initialized indicators 11 of each state should correspond in number to the initialized numeric quantities.

The methods of the present invention also include the step of monitoring the input(s) 12 to detect a selection or change of value of one of the numeric quantities. The selection of a value for the numeric quantity or change in value of the numeric quantity will trigger an automatic update to the states of the indicators 11 to reflect the new numeric quantity values. In addition, the selection of a value or change in value of the numeric quantity may also trigger an automatic change to the value of another numeric quantity to ensure that the sum of the numeric quantities is equal to the set amount of package content units. The monitoring is preferably performed by computer software, most preferably a client-side script, that detects a change to the value of any of the numeric quantities, and then captures the data in a database, session variable, cookie, HTML form element, or the like for further processing.

The methods or graphical user interface of the present invention additionally includes setting the state of one or more indicators 11 after the selection of a value or change in value for the numeric quantities. After a selection of a value or change in value occurs, the state of each indicator 11 will be updated, if necessary, to reflect the selected numeric quantity values. Thus, the number of indicators 11 set to each state will correspond to the numeric quantity value selected for each of the discrete types of units. It is preferred that the indicators 11 are presented to the user in groupings according to their state.

In an embodiment, the methods of the present invention may further include the step of receiving a request from the user to purchase the chosen custom assortment. In a preferred embodiment, the request is sent over a computer network, such as the Internet, and received at a remote computer. The request may include the selected numeric quantity values for each of the discrete unit types, preferably as key/value pairs. Furthermore, the methods of the present invention may include the step of packing a package with a quantity of units of each of the discrete types that is equal to the corresponding numeric quantity included with the request. The package is then shipped to the user that requested the custom assortment. This aspect of the invention may also include providing a printout or other representation of the indicators 11 in their final state at the time of the purchase request, or otherwise communicating, such as via a computer network, the final confirmed selection of the user, to the individual or machine filling the order, i.e., packing the package, to confirm the accuracy of the package contents prior to shipping to the purchaser.

The present invention is also directed to a graphical user interface comprising an array of indicators, wherein each indicator is configured to convert between two or more visually-distinguishable states, and wherein each indicator corresponds to one of a set amount of package content units, and one or more inputs for selecting two or more numeric quantities, wherein the inputs are configured to prevent the sum of the numeric quantities from exceeding the set amount of package content units, wherein, for each of the numeric quantities, an equivalent number of indicators are in one of the visually-distinguishable states.

The computer system(s) employed in the methods of the present invention, particularly for presenting the graphical user interface, may contain a central processing unit (CPU) that executes computer programs stored on a memory. Memory in one embodiment comprises one or more levels of cache as desired to speed execution of the program and access to data on which the programs operate. The CPU is directly coupled to memory with both CPU and memory coupled to a bus. A storage, I/O and communications are also coupled to the bus. Storage is usually a long term storage device, such as a disk drive, tape drive, DVD, CD or other type of storage device. I/O comprises keyboards, sound devices, displays, mouse, touchpads and other mechanisms by which a user interacts with the computer system. Communications comprises a network, phone connection, local area network, wide area network or other mechanism for communicating with external devices. Such external devices comprise servers, other peer computers and other devices. Other computer system architectures capable of executing software may also be used. Additionally, appropriate security measures such as encryption are used to ensure confidentiality and data integrity.

### EXAMPLE 1

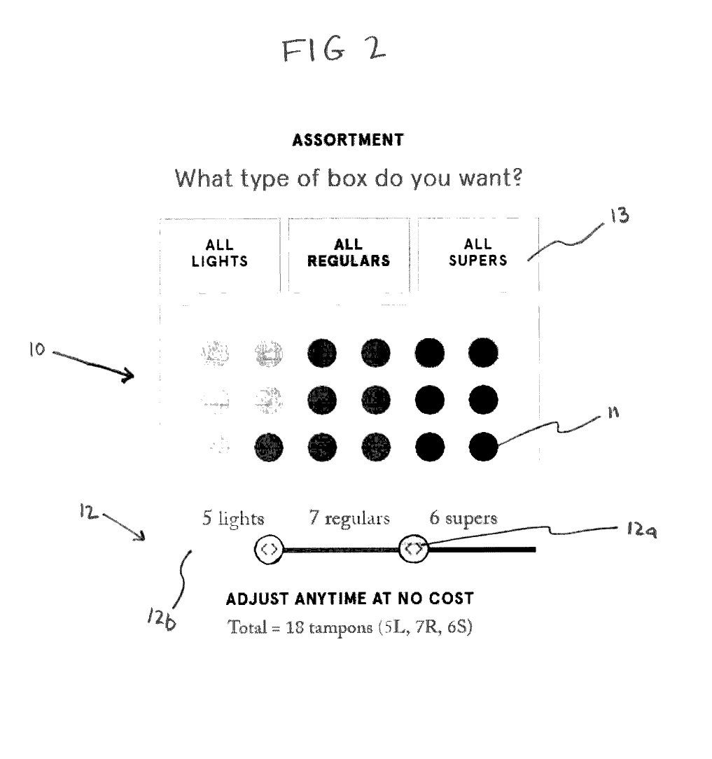

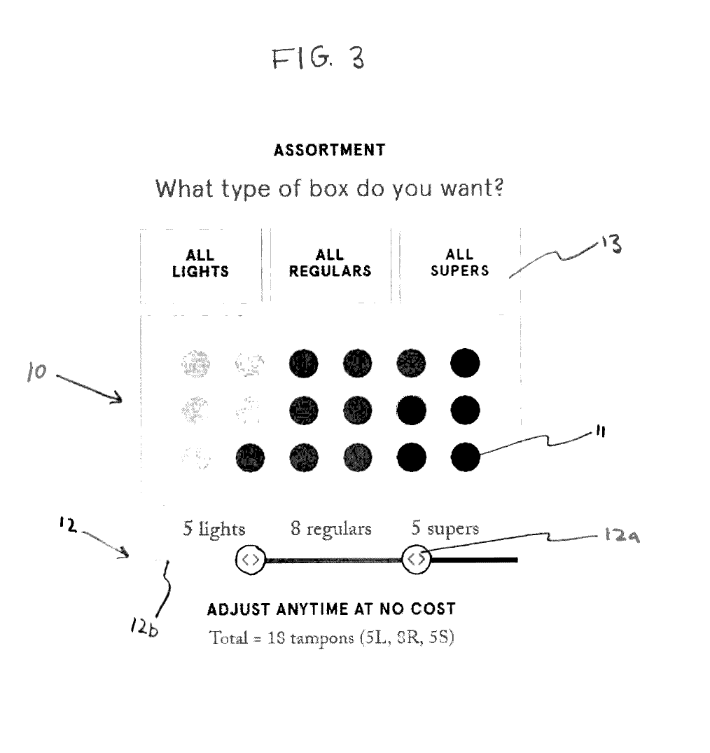

The following is an example of how an embodiment of the present invention would work in practice for the selection of a custom assortment of tampons, with the set amount of package units being 18, and with discrete types available for selection being light, regular, and super absorbency. As shown in FIG. 1, when a user accesses the graphical user interface 10, an array of indicators 11 is displayed along with a single input slider 12 having two handles 12a. The indicators 11 and input 12 are initialized to six lights, six regulars, and six supers, i.e., there are six indicators 11 of a first color state corresponding to lights, six indicators 11 of a second color state corresponding to regulars, and six indicators 11 of a third color state corresponding to supers. FIG. 2 shows how the indicators 11 change state once a selection has been made. In particular, the user dragged the left-most handle 12a to the left of the slider input 12, thereby selecting a numeric quantity for lights of five, which also had the consequence of increasing the numeric quantity of regulars to seven, thereby ensuring that the sum of the numeric quantities equals 18. In response, the indicators 11 automatically updated to five indicators 11 of the first color state corresponding to lights, seven indicators 11 of the second color state corresponding to regulars, and six indicators 11 of the third color state corresponding to supers. FIG. 3 shows the indicators 11 changing upon a further selection by the user. In particular, the user dragged the right-most handle 12a to the right of the slider input 12, thereby selecting a numeric quantity for supers of five, which also had the consequence of increasing the numeric quantity of regulars to eight, thereby ensuring that the sum of the numeric quantities equals 18. In response, the indicators 11 automatically updated to five indicators 11 of the first color state corresponding to lights, eight indicators 11 of the second color state corresponding to regulars, and five indicators 11 of the third color state corresponding to supers.

Implementation of the invention other than as described herein may involve products other than tampons/menstrual pads and/or utilize software or graphical user interface designs other than that depicted in the Figures, as would be apparent to a person skilled in the art.

It is envisioned that any feature or element that is positively identified in this description may also be specifically excluded as a feature or element of an embodiment of the present invention as defined in the claims.

The invention described herein may be practiced in the absence of any element or elements, limitation or limitations which is not specifically disclosed herein. Thus, for example, in each instance herein, any of the terms “comprising,” “consisting essentially of” and “consisting of” may be replaced with either of the other two terms. The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the claims.

1. A method of dynamically displaying in a graphical user interface a visual representation of a set amount of package content units, whereby each unit may be selected by a user from among two or more discrete types, the method comprising:
a) displaying to the user an array of indicators, wherein each indicator corresponds to one of the set amount of package content units and is capable of two or more visually-distinguishable states;
b) displaying to the user at least one input for selecting at least two numeric quantities, whereby each of the numeric quantities corresponds to a desired quantity of units of one of the discrete types, and whereby the inputs are configured to prevent the sum of the numeric quantities from exceeding the set amount of package content units;
c) monitoring the inputs to detect a selection of at least one of the numeric quantities; and
d) automatically setting the state of one or more indicators, whereby each state corresponds to units of one of the discrete types, and whereby the number of indicators set to each state is the same as the selected numeric quantity for units of the corresponding discrete type.

2. The method of claim 1 wherein the visually-distinguishable states are visually distinguished by color.

3. The method of claim 1 wherein the visually-distinguishable states are visually distinguished by shape.

4. The method of claim 1 wherein the visually-distinguishable states are visually distinguished by pattern.

5. The method of claim 1 wherein the input is a slider with a number of handles that divide the slider into a number of portions corresponding to the number of discrete types of units.

6. The method of claim 5 wherein the number of handles is two and the number of portions is three.

7. The method of claim 1 further comprising:
e) receiving over a computer network a request from the user that includes the numeric quantities for units of each of the discrete types; and
f) packing a package with a quantity of units of each of the discrete types that is equal to the corresponding numeric quantity included with the request.

8. The method of claim 7 wherein the units are tampons and the discrete types comprise light absorbency, regular absorbency, super absorbency, and super-plus absorbency, or wherein the units are menstrual pads and the discrete types comprise day and night.

9. A method of dynamically displaying in a graphical user interface a visual representation of a set amount of package content units, whereby each unit may be selected by a user from among two or more discrete types of units, the method comprising:
a) displaying to the user an array of indicators, wherein each indicator corresponds to one of the set amount of package content units and is capable of two or more visually-distinguishable states, and wherein each indicator is initialized to one of the states;
b) displaying to the user one or more inputs for selecting two or more numeric quantities, whereby each of the numeric quantities corresponds to a desired quantity of units one of the discrete types, and whereby the numeric quantities are each initialized to a value such that the sum of the numeric quantities is equal to the set amount of package content units;
c) monitoring the inputs to detect a change to the value of one of the numeric quantities;
d) automatically changing the value of one or more of the other numeric quantities such that the sum of the numeric quantities is equal to the set amount of package content units; and
e) automatically setting the state of one or more indicators, whereby each state corresponds to units of one of the discrete types, and whereby the number of indicators set to each state is the same as the selected numeric quantity for units of the corresponding discrete type.

10. The method of claim 9 wherein the visually-distinguishable states are visually distinguished by color.

11. The method of claim 9 wherein the visually-distinguishable states are visually distinguished by shape.

12. The method of claim 9 wherein the visually-distinguishable states are visually distinguished by pattern.

13. The method of claim 9 wherein the input is a slider with a number of handles that divide the slider into a number of portions corresponding to the number of discrete types of units.

14. The method of claim 13 wherein the number of handles is two and the number of portions is three.

15. The method of claim 9 further comprising:
e) receiving over a computer network a request from the user that includes the numeric quantities for units of each of the discrete types; and
f) packing a package with a quantity of units of each of the discrete types that is equal to the corresponding numeric quantity included with the request.

16. The method of claim 15 wherein the units are tampons and the discrete types comprise light absorbency, regular absorbency, super absorbency, and super-plus absorbency, or wherein the units are menstrual pads and the discrete types comprise day and night.

17. The method of claim 9 wherein step (a) further comprises initializing each indicator to one of the states such that there are an equal number of indicators of each state, and wherein step (b) further comprises initializing the numeric quantities to the same value.

18. A graphical user interface comprising:
an array of indicators, wherein each indicator is configured to switch between two or more visually-distinguishable states, and wherein each indicator corresponds to one of a set amount of package content units;
one or more inputs for selecting two or more numeric quantities, wherein the inputs are configured to prevent the sum of the numeric quantities from exceeding the set amount of package content units; and
wherein, for each of the numeric quantities, an equivalent number of indicators are in one of the visually-distinguishable states.
